(19) United States
(12) Patent Application Publication
(10) Pub. No.: US 2007/0207028 A1
(43) Pub. Date: Sep. 6, 2007

(54) WATER CURRENT TURBINE

(76) Inventors: Peter Nicholas, Bristol (GB); Andrew Verel, Bristol (GB)

Correspondence Address: GIFFORD, KRASS, SPRINKLE,ANDERSON & CITKOWSKI, P.C, PO BOX 7021, TROY, MI, 48007-7021, US

(21) Appl. No.: 11/568,208

(22) PCT Filed: Apr. 22, 2005
(86) PCT No.: PCT/GB05/01561

§ 371 Date: Dec. 18, 2006

(30) Foreign Application Priority Data
Apr. 22, 2004 (GB) 0408939.7

(51) Int. Cl. F03B 13/12

(52) U.S. Cl. 415/3.1

(57) ABSTRACT

A turbine system (10, 110) includes a support (12, 112) carrying a platform (21, 121) on an upper portion thereof, wherein the support (12, 112) is adapted to be partially submerged within a body of flowing water such that the platform (21, 121) is raised from the water. One or more elongate members (22, 122) are provided which support a turbine assembly (26, 126) at one end are pivotally coupled at an opposite end to the support (12, 112) such that each elongate member (22, 122) may be pivoted to move the associated turbine assembly (26, 126) between raised and lowered positions, out of and into the body of water. In a disclosed embodiment, the elongate member (22, 122) is adapted to be releasably secured relative to the platform (21, 121) when the turbine assembly (26, 126) is located in the raised position.

### FIELD OF INVENTION

The present invention relates to turbines, and in particular, but not exclusively, to turbines actuated by a flow of water, such as a tidal stream.

### BACKGROUND OF INVENTION

Numerous efforts have been made to enable the efficient production of electricity without exploiting finite resources, such as fossil and nuclear fuels, which generate numerous environmental concerns. For example, techniques exist for extracting the kinetic energy from renewable resources such as flowing air or water. Such techniques include, for example, providing wind turbines to extract energy from the wind, and water turbines to extract energy from flowing water, such as a tidal stream. The turbines used in both cases may be of the same general form; the provision of a number of blades mounted about a shaft, wherein impingement of fluid on the blades produces the effect of lift which in turn produces a turning moment about the central axis of the shaft, resulting in shaft work. This shaft work may then be used to drive an electric generator.

Where water turbines are to be used for extracting energy from a tidal flow, considerations must be made in submerging and maintaining the turbines within the body of flowing water, and subsequently retrieving the turbines from the water for maintenance, replacement or the like. It is known in the art to provide a vertical column upstanding from the seabed, wherein one or more water turbine units are mounted on the column. The turbines may be mounted on the column by means of a sleeve which is axially displaceable lengthways of the column. Such an arrangement is disclosed in international patent application publication no. WO 00/50768, wherein the sleeve and turbine unit are axially displaceable using a rack and pinion arrangement. It is also known from WO 00/50768 to fix the turbine unit to a strut which is pivoted about a pinned joint on the column, such that the turbine unit may be raised by pivoting the strut about its pivot. However, it is apparent from WO 00/50768 that access to the turbines once in a raised position would be required to be made from a floating platform or other like structure, which is potentially hazardous for the personnel involved. Additionally, such access may prove difficult as the floating platform would, in effect, move relative to the turbine unit and strut.

It is an object of the present invention to obviate or at least mitigate these and other problems with the prior art.

### SUMMARY OF INVENTION

According to a first aspect of the present invention, there is provided a water flow actuated turbine system comprising:

a support adapted to be partially submerged within a body of flowing water;

a platform mounted on an upper portion of the support; and

an elongate member supporting a turbine assembly at one end and being pivotally coupled at an opposite end to the support, the elongate member being pivotable to move the turbine assembly between raised and lowered positions, wherein at least one of the turbine assembly and elongate member is adapted to be releasably secured relative to the platform when the turbine is located in the raised position.

Preferably, the upper portion of the support upon which the platform is mounted extends above the body of flowing water in which the support is partially submerged when in use.

Thus, in use, the elongate member may be pivoted to move the turbine assembly to its raised position where it is lifted clear of the body of water, with the elongate member and/or the turbine assembly being secured to the platform. This arrangement allows personnel to access the turbine assembly directly from the safety of the platform in order to carry out any required maintenance and repair work, or to remove the turbine assembly from the system. Once any work is completed, the elongate member and turbine assembly, or a replacement turbine assembly, may be released from the platform and submerged in the body of water for operational cooperation with the water flow by pivoting the elongate member in an opposite direction.

Preferably, the platform is adapted to accommodate the form of the turbine assembly such that full access to the turbine assembly may be achieved from the platform while the turbine assembly is located and secured in a raised position. This arrangement assists to ensure the safety of any personnel working with the turbine assembly.

Advantageously, at least one of the turbine assembly and elongate member is releasably secured relative to the platform by a latching mechanism, tether device, bolting arrangement or the like.

In a preferred embodiment of the present invention, the elongate member is adapted to be releasably secured to the platform. Thus, the turbine assembly may be uncoupled and removed from the elongate member while said member is secured relative to the platform.

Advantageously, the turbine assembly may be releasably secured to the elongate member by a bolting arrangement, latching mechanism, tether device, pinned joint or the like. The elongate member may include a flange portion adapted to engage and support the turbine assembly.

Beneficially, the turbine assembly is adapted to be at least part uncoupled from the elongate member when at least one of the turbine assembly and elongate member is secured relative to the platform. This arrangement permits the elongate member to be pivoted to move the at least partly uncoupled turbine assembly towards the surface of the body of water, where the turbine assembly may be completely uncoupled from the elongate member for removal. Partly uncoupling the turbine assembly from the elongate member when in the raised position permits a large portion of the uncoupling procedure to be carried out from the platform, thus minimising the risk to personnel.

In a preferred embodiment of the present invention, the turbine assembly is adapted to be coupled to the elongate member by a temporary connection during removal of the turbine assembly from the elongate member. In this arrangement, when at least one of the turbine assembly and elongate member is secured relative to the platform, the turbine assembly may be uncoupled from the elongate member and subsequently re-coupled thereto by the temporary connection. Once the temporary connection is in place the elongate member may be pivoted to move the turbine assembly towards the surface of the body of water, where the temporary connection may be disengaged to release the turbine assembly from the elongate member. Preferably, the temporary connection is a quick release connection. Advantageously, the temporary connection may incorporate a clamping arrangement, latching mechanism or the like.

Preferably, the turbine assembly includes a rotor unit carrying a plurality of blades, and a generator coupled to the rotor unit. Thus, when the turbine assembly is located within a flow of water, the resulting lift forces acting on the blades will cause rotation of the rotor which in turn will drive the generator to produce electrical current. The generator may be directly driven by the rotor. Alternatively, the turbine assembly may further include speed increasing transmission means located between the rotor and the generator in order to increase the rotational output from the rotor caused by a flow of water, to a level suitable for driving the generator to produce a satisfactory electrical current. The speed increasing transmission means may be a mechanical gearbox or a hydraulic transmission system or the like.

Preferably, the turbine assembly further comprises a mechanism for controlling the pitch of the blades with respect to the direction of flow of water in which the turbine assembly is submerged when in use. Advantageously, the pitch control mechanism is adapted to selectively position the blades to present a leading edge of each blade into the flow. Effective control of the pitch of the blades allows the turbine assembly to operate in conditions where the direction of water flow is not consistent, such as is the case with tidal flow where the direction of flow is cyclically reversed in accordance with flow and ebb tides. Preferably, a control system is provided to ensure an optimum blade pitch is achieved and maintained; that is, the angle of attack of the blades is selectively controlled to maximise the speed of the generator over a full range of flow velocities and directions. Preferably, the control system also utilises an AC motor drive system to manage the generator torque thus ensuring the optimum power balance is achieved.

Preferably, the turbine assembly is contained within a single bulb or nacelle. Advantageously, the bulb or nacelle is hydrodynamically formed in order to minimise the effects of drag forces imparted on the turbine system.

Preferably, any electrical current produced by the generator is carried along suitable conducting cables which may extend from the turbine assembly and through or along the elongate member. The conducting cables may also extend through or along the length of the support. Advantageously, the conducting cables may extend along the floor of the body of water (hereinafter referred to as ‘seabed’ for convenience) to a suitable location such as an on shore electrical substation or the like.

Advantageously, the support may be a column adapted to be directly mounted on a seabed. Alternatively, the support may be adapted to be embedded within a seabed. For example, the support may be locatable within a socket embedded into the seabed. Alternatively further, the support may be or form part of a floating structure. This may be advantageous where the turbine system is to be located in a relatively deep body of water.

Preferably, the system further comprises a float arrangement adapted to cause the elongate member to pivot on the support. Advantageously, the float arrangement may comprise a float member, preferably located within the support. In an alternative embodiment the float member may be located outwith the support member. Preferably, a rigging system is secured between the float member and at least one of the elongate arm and turbine assembly. More preferably, the rigging system is secured between the float member and the elongate member. The rigging system may comprise a chain, wire rope or the like.

Preferably, in use, lowering of the float member relative to the support causes the elongate member to pivot to move the turbine assembly towards the raised position, and raising the float member relative to the support causes the elongate member to pivot to move the turbine assembly towards the lowered position.

In a preferred embodiment of the present invention, the float arrangement comprises a pumping system to effect raising and lowering of the float member in a controlled manner. Advantageously, the pumping system is adapted to pump water into and from the float member to vary the buoyancy thereof. Preferably, the float member is positioned within the support and the pumping arrangement is adapted to displace water from within the support and into the float member, and vice versa, in order to raise and lower said float member.

Advantageously, the float arrangement may be accessed from a suitable entry point in the support, preferably gained from the platform. Thus, substantially full maintenance of the turbine system may be achieved from the safety of the platform.

In an alternative embodiment, the elongate member may be caused to pivot on the support by a winch arrangement. Conveniently, the winch arrangement may include a winching mechanism such as a motor, and a rigging system secured between the winching mechanism and the elongate arm. Advantageously, the rigging system is coupled to the elongate arm at any suitable position along the length thereof. Preferably, the winching mechanism and required control systems and the like are housed within the support. Advantageously, the winching mechanism may be accessed from a suitable entry point in the support, preferably gained from the platform.

Preferably, the turbine assembly may be raised, or at least partially raised by selectively controlling the buoyancy of the turbine assembly, such that the turbine assembly may be ‘floated’ to the surface of the body of water in which it is located when in use. The turbine assembly may comprise one or more buoyancy chambers adapted to be selectively filled with and emptied of water. Advantageously, a pumping assembly may be utilised to fill or empty the one or more buoyancy chambers. Alternatively, or additionally, water may be displaced from the one or more buoyancy chambers by air pressure.

In a preferred embodiment, the turbine system further comprises a turbine assembly supporting structure, preferably mounted on at least one of the elongate member and turbine assembly, wherein the turbine assembly supporting structure abuts against the support when the turbine assembly is located in a lowered position. Advantageously, the turbine assembly supporting structure is adapted to be locked against the support to prevent unintentional separation caused by, for example, larger water flow rates. Preferably, the turbine assembly supporting structure is locked against the support by a locking mechanism controlled from, for example, the region of the platform.

In an alternative embodiment, the turbine system may further comprise a turbine assembly supporting structure, mounted on the support, wherein the turbine assembly abuts against and becomes at least partially supported by the turbine assembly supporting structure when the turbine assembly is located in a lowered position. Advantageously, the turbine assembly is adapted to be locked against the supporting structure to prevent unintentional separation. The turbine assembly may be locked against the supporting structure by a locking mechanism.

In a preferred embodiment of the present invention, the turbine assembly includes two elongate members and associated turbine assemblies.

Preferably, the turbine system is a tidal flow turbine system.

According to a second aspect of the present invention, there is provided a method of accessing a turbine assembly of a water flow actuated turbine system comprising a support partially submerged within a body of flowing water, a platform mounted on an upper portion of the support extending above the body of water, and an elongate member supporting the turbine assembly at one end and being pivotally coupled at an opposite end to the support, the method comprising the steps of:

pivoting the elongate member to move the turbine assembly from a lowered position to a raised position above the body of water; and

securing at least one of the elongate member and turbine assembly relative to the platform.

Preferably, the elongate member is pivoted by raising and lowering of a float member coupled to at least one of the elongate member and turbine assembly by a rigging system.

Preferably, the method farther comprises the step of varying the buoyancy of the turbine assembly to assist to move said turbine assembly towards the raised position.

According to a third aspect of the present invention, there is provided a water flow actuated turbine system comprising:

a support adapted to be at least partially submerged within a body of flowing water;

an elongate member supporting a turbine assembly at one end and being pivotally coupled at an opposite end to the support, the elongate member being pivotable to move the turbine assembly between raised and lowered positions; and

a float arrangement comprising a float member coupled to at least one of the elongate member and turbine assembly via a rigging system, wherein the buoyancy of the float member is variable to raise and lower the float member relative to the support to cause the elongate member to pivot to move the turbine assembly between raised and lowered positions.

Preferably, the float member is located within the support and is adapted to be submerged within a volume of water within said support to varying degrees by varying the buoyancy of said float member.

Advantageously, the buoyancy of the float member may be variable by varying the proportions of water and air contained therein.

Preferably, the float arrangement comprises a pumping system adapted to pump water into and from the float member. In a preferred embodiment, the pumping system is adapted to displace water from within the support and into the float member, and vice versa.

According to a fourth aspect of the present invention, there is provided a lifting arrangement for use in a water flow actuated turbine system comprising an elongate member carrying a turbine assembly, said elongate member being pivotally mounted on a support adapted to be at least partially submerged in a body of water, wherein the elongate member is pivotable to move the turbine assembly between raised and lowered positions, said lifting arrangement comprising:

a float member coupled to at least one of the elongate member and turbine assembly via a rigging system, wherein the buoyancy of the float member is variable to raise and lower the float member relative to the support to cause the elongate member to pivot to move the turbine assembly between raised and lowered positions.

According to a fifth aspect of the present invention, there is provided a water flow actuated turbine system comprising;

a support adapted to be at least partially submerged within a body of flowing water;

a turbine assembly mounted on the support and adapted to be moved between a raised position in which the turbine assembly is at least partially removed from the body of water, and a lowered position in which the turbine assembly is at least partially submerged within the body of water; and

a float arrangement comprising a float member coupled to the turbine assembly via a rigging system, wherein the buoyancy of the float member is variable to raise and lower the float member relative to the support to move the turbine assembly between said raised and lowered positions.

Advantageously, the float member may be directly coupled to the turbine assembly via the rigging system. Alternatively, the float member may be indirectly coupled to the turbine assembly by the rigging system, for example via a turbine assembly support arrangement.

The turbine assembly support arrangement may comprise an elongate member, one end of which elongate member being adapted to support the turbine assembly, and an opposite end of the elongate member being pivotally coupled to the support. In this arrangement, the elongate member is caused to pivot to move the turbine assembly between raised and lowered positions.

Alternatively, the turbine assembly support arrangement may comprise a mounting structure, such as a plate or collar or the like, slidably mounted on the support and adapted to be moved lengthways of the support to move the turbine assembly between raised and lowered positions.

### BRIEF DESCRIPTION OF THE DRAWING

These and other aspects of the present invention will now be described, by way of example only, with reference to the accompanying drawings, in which:

FIG. 1 is a diagrammatic representation of a turbine system in accordance with one embodiment of the present invention; and

FIG. 2 is a diagrammatic representation of a turbine system in accordance with an alternative embodiment of the present invention.

### DETAILED DESCRIPTION OF THE DRAWING

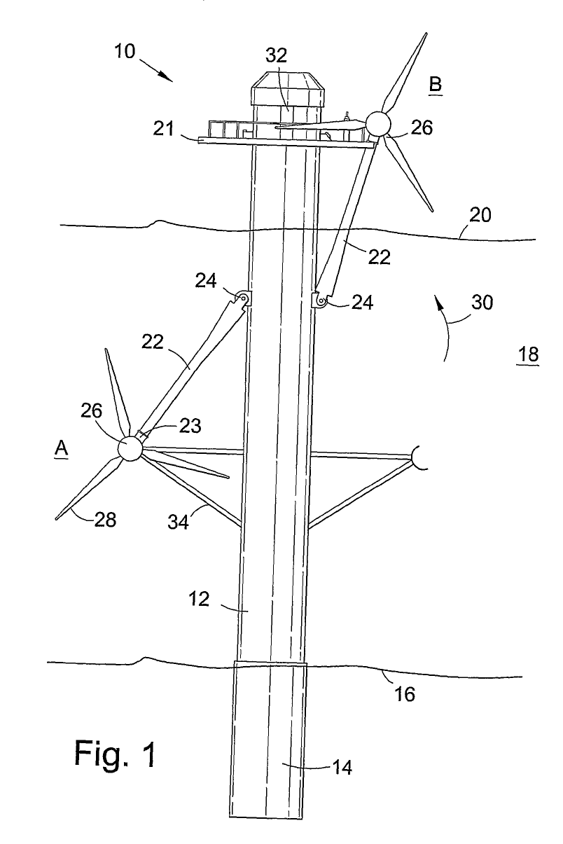

Referring to FIG. 1, there is shown a turbine system, generally indicated by reference numeral 10, in accordance with one embodiment of the present invention, for use in converting the kinetic energy in a tidal flow to electrical energy. The turbine system 10 comprises a column support 12 located in a socket 14 which is embedded into the bed 16 of a body of water 18. The body of water 18 may be any body of water subject to tidal flow. A platform 21 is mounted on the upper portion of the column support 12, above the surface 20 of the water 18.

The turbine system 10 further comprises a pair of elongate members or pylons 22, each of which are pivotally coupled at one end to the column support 12 at respective hinges 24, and support a turbine assembly 26 at the opposite end via respective flange portions 23. Each turbine assembly 26 includes a rotor unit carrying a plurality of blades 28, and a generator (not shown) coupled to the rotor unit via a gear box (not shown). Thus, when a turbine assembly 26 is located within the body of water 18, the tidal flow produces lift forces which act on the blades 28 causing rotation of the rotor which in turn will drive the generator to produce electrical current. Each turbine assembly 26 further comprises a mechanism (not shown) for controlling the pitch of the blades 28 with respect to the direction of flow of water. A control system (not shown) is also provided to ensure an optimum blade pitch is maintained; that is, the angle of attack of the blades 28 is selectively controlled to optimise the speed of the generator over a full range of tidal flow velocities and directions.

Each turbine assembly 26 may be raised from the body of water 18 by pivoting the pylon 22 against its hinge 24 in the direction of arrow 30. In this way, the turbine assembly 26 may be moved from position A to position B, where the turbine assembly 26 is lifted clear of the body of water 18. Once in a raised position (position B), the pylon 22 is secured to the platform 21 by a suitable mechanism (not shown). This arrangement allows personnel to access the turbine assembly 26 directly from the safety of the platform 21 in order to carry out any required maintenance and repair work. Once any work is completed, the pylon 22 may be released from the platform 21 and re-submerged in the body of water 18 for operational cooperation with the water flow, by pivoting the pylon 22 in a reverse direction.

The platform 21 is adapted to accommodate the form of the turbine assembly 26 such that full access to the turbine assembly 26 may be achieved from the platform 21 while the turbine assembly is located and secured in a raised position. This arrangement assists to ensure the safety of any personnel working with the turbine assembly 26.

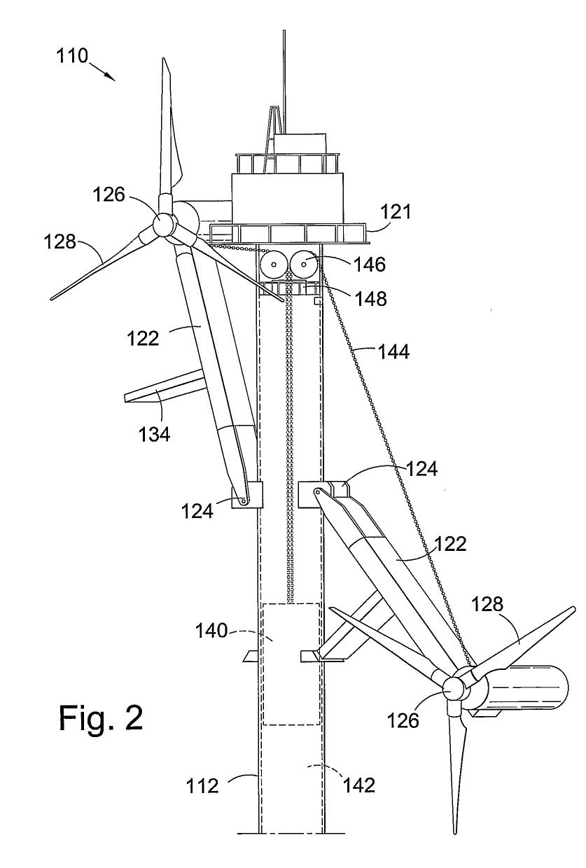

In the embodiment shown, the pylons 22 and respective turbine assemblies 26 are caused to pivot by a float arrangement (not shown), which will be described in detail below with reference to FIG. 2.

The turbine system 10 further comprises turbine assembly support structures 34, which in the embodiment shown are mounted on the column 12, wherein, as shown, each turbine assembly 26 abuts against and becomes at least partially supported by a support structure 34 when the turbine assembly 26 is located in a lowered position (position A). Each turbine assembly 26 is locked against a respective support structure 34 to prevent unintentional separation caused by, for example, larger water flow rates. Each turbine assembly 26 is locked against the supporting structure by a locking mechanism (not shown) controlled from the region of the platform 21.

Reference is now made to FIG. 2 of the drawings in which there is shown a turbine system, generally indicated by reference numeral 110, in accordance with an alternative embodiment of the present invention. It should be noted that turbine system 110 is similar to that shown in FIG. 1, and as such like components share like reference numerals, preceded by a ‘1’.

The turbine system 110 comprises a column 112 which supports a platform 121 on an upper portion thereof. A pair of pylons 122 are pivotally coupled at one end to the column 112 at respective hinges 124, and support a respective turbine assembly 126 at the opposite end. Each turbine assembly 126 includes a rotor unit carrying a plurality of blades for driving the rotor unit, and associated generator (not shown), when the turbine assembly 126 is positioned within a moving body of water.

In the same manner as described above with reference to the system 10 shown in FIG. 1, each turbine assembly 126 may be raised from and lowered into a body of water by pivoting the associated pylon 122 against its hinge 124. When in a fully raised position, as shown on the left hand side in FIG. 2, the pylon 122 and turbine assembly 126 are secured relative to the platform 121.

The turbine system 110 incorporates a float arrangement for use in assisting to raise and lower the pylons 122 and associated turbine assemblies 126. The float arrangement comprises a float member 140 located within the column 112, wherein the column 112 contains a volume of water 142 which the float member is adapted to be submerged within to varying degrees.

A length of chain 144 extends between each pylon 122 and the float member 140 and passes over a respective fairlead 146 positioned in an upper portion of the column 112. The arrangement is such that when the float member 140 is lowered within the column 112, the pylons 122 and associated turbine assemblies 126 will be moved towards a raised position, and vice versa. When the elongate member 122 is in a raised position, the float member 140 and chain 144 act to retain the elongate member 122 in said raised position until suitably secured to the platform.

The float arrangement comprises a pumping system which incorporates a pump unit 148 adapted to selectively displace water from within the column 112 and into the float member 140, and vice versa, in order to vary the effective buoyancy and weight of the float member 140 to cause said float member 140 to be raised and lowered within the column 112.

In the embodiment shown, each turbine assembly 126 comprises a buoyancy chamber (not shown) which is adapted to be selectively filled with varying proportions of air and water to vary the effective buoyancy of each assembly 126. This arrangement permits the effective buoyancy of the turbine assemblies 126 to be increased to cause the assemblies to be ‘floated’ to the surface of the body of water in which the system 110 is located, and thus towards the raised position. This chamber also enables the nacelle to be floated, with or without additional floatation devices, away from the system 110 for maintenance, replacement or the like. In the preferred arrangement shown, once a turbine assembly 126 has been raised to the surface of the body of water by the effect of buoyancy, the float arrangement then raises the turbine assembly 126 from the surface of the body of water to the fully raised position in which the pylon 122 is secured to the platform 121.

The turbine system 110 further comprises turbine assembly support structures 134 mounted on each pylon 122, wherein each support structure 134 abuts against and becomes at least partially supported by the column 112. Each turbine assembly support structure 134 is locked against the column 112 by a locking mechanism (not shown) controlled from the region of the platform 121.

It should be understood that the embodiments described are merely exemplary of the present invention and that various modifications may be made thereto without departing from the scope of the invention. For example, the column may be directly mounted on the surface of the seabed, or may be, or form part of, a floating structure. Additionally, a winching arrangement may be utilised to raise and lower the turbine assemblies. Furthermore, the pylons may incorporate buoyancy chambers to be used in assisting to raise and lower the turbine assemblies.

1. A water flow actuated turbine system comprising:
a support adapted to be partially submerged within a body of flowing water;
a platform mounted on an upper portion of the support; and
an elongate member supporting a turbine assembly at one end and being pivotally coupled at an opposite end to the support, the elongate member being pivotable to move the turbine assembly between raised and lowered positions, wherein at least one of the turbine assembly and elongate member is adapted to be releasably secured relative to the platform when the turbine assembly is located in the raised position.

2-54. (canceled)

55. The system of claim 1, wherein the upper portion of the support upon which the platform is mounted extends above the body of flowing water in which the support is partially submerged when in use.

56. The system of claim 1, wherein the platform is adapted to accommodate the turbine assembly in said raised position.

57. The system of claim 1, wherein at least one of the turbine assembly and elongate member is releasably secured relative to the platform by a latching mechanism.

58. The system of claim 1, wherein at least one of the turbine assembly and elongate member is releasably secured relative to the platform by a bolting arrangement.

59. The system of claim 1, wherein the elongate member is adapted to be releasably secured relative to the platform.

60. The system of claim 1, wherein the turbine assembly is releasably secured to the elongate member by a bolting arrangement.

61. The system of claim 1, wherein the turbine assembly is releasably secured to the elongate member by a latching mechanism.

62. The system of claim 1, wherein the turbine assembly is releasably secured to the elongate member by a pinned joint.

63. The system of claim 1, wherein the elongate member includes a flange portion adapted to engage and support the turbine assembly.

64. The system of claim 1, wherein the turbine assembly is adapted to be at least part uncoupled from the elongate member when at least one of the turbine assembly and elongate member is secured relative to the platform.

65. The system of claim 1, wherein the turbine assembly is adapted to be coupled to the elongate member by a temporary connection during removal of the turbine assembly from the elongate member.

66. The system of claim 65, wherein the temporary connection is a quick release connection.

67. The system of claim 65, wherein the temporary connection incorporates a clamping arrangement.

68. The system of claim 1, wherein the turbine assembly includes a rotor unit carrying a plurality of blades, and a generator coupled to the rotor unit.

69. The system of claim 68, wherein the generator is directly driven by the rotor.

70. The system of claim 68, wherein the turbine assembly include speed increasing transmission means located between the rotor and the generator

71. The system of claim 68, wherein the turbine assembly further comprises a mechanism for controlling the pitch of the blades with respect to the direction of flow of water in which the turbine assembly is submerged when in use.

72. The system of claim 71, further comprising a control system to ensure an optimum blade pitch is achieved and maintained.

73. The system of claim 72, wherein the control system comprises an AC motor drive system adapted to optimise the output of the generator.

74. The system of claim 1, wherein the support comprises a column.

75. The system of claim 1, wherein the support is adapted to be directly mounted on a seabed.

76. The system of claim 1, wherein the support is adapted to be embedded within a seabed.

77. The system of claim 1, wherein the support forms part of a floating structure.

78. The system of claim 1, further comprising a float arrangement adapted to cause the elongate member to pivot on the support.

79. The system of claim 78, wherein the float arrangement comprises a float member.

80. The system of claim 79, wherein the float member is located within the support.

81. The system of claim 79, further comprising a rigging system secured between the float member and at least one of the elongate arm and turbine assembly.

82. The system of claim 79, wherein, in use, lowering of the float member relative to the support causes the elongate member to pivot to move the turbine assembly towards the raised position, and raising the float member relative to the support causes the elongate member to pivot to move the turbine assembly towards the lowered position.

83. The system of claim 79, wherein the float arrangement comprises a pumping system to effect raising and lowering of the float member.

84. The system of claim 83, wherein the pumping system is adapted to pump water into and from the float member to vary the buoyancy thereof.

85. The system of claim 84, wherein the float member is positioned within the support and the pumping arrangement is adapted to displace water from within the support and into the float member, and vice versa, in order to raise and lower said float member.

86. The system of claim 1, wherein the turbine assembly is at least partially raised by selectively controlling the buoyancy of the turbine assembly.

87. The system of claim 86, wherein the turbine assembly comprises at least one buoyancy chamber adapted to be selectively filled with and emptied of water.

88. The system of claim 1, wherein the buoyancy of the turbine assembly is controllable to permit said turbine assembly to be transmitted by a suitable towing vessel.

89. The system of claim 1, wherein the turbine assembly is adapted to be secured to at least one floatation device to permit said turbine assembly to be transported by a suitable towing vessel.

90. The system of claim 1, further comprising a turbine assembly supporting structure mounted on at least one of the elongate member and turbine assembly, wherein the turbine assembly supporting structure abuts against the support when the turbine assembly is located in a lowered position.

91. The system of claim 90, wherein the turbine assembly supporting structure is adapted to be locked against the support.

92. The system of claim 1, further comprising a turbine assembly supporting structure mounted on the support wherein the turbine assembly abuts against and becomes at least partially supported by the turbine assembly supporting structure when the turbine assembly is located in a lowered position.

93. The system of claim 1, comprising two elongate members and associated turbine assemblies.

94. The system of claim 1, wherein the turbine system is a tidal flow turbine system.

95. A method of accessing a turbine assembly of a water flow actuated turbine system comprising a support partially submerged within a body of flowing water, a platform mounted on an upper portion of the support extending above the body of water, and an elongate member supporting the turbine assembly at one end and being pivotally coupled at an opposite end to the support, the method comprising the steps of:
pivoting the elongate member to move the turbine assembly from a lowered position to a raised position above the body of water; and
securing at least one of the elongate member and turbine assembly relative to the platform.

96. The method of claim 95, further comprising the step of pivoting the elongate member by raising and lowering a float member coupled to at least one of the elongate member and turbine assembly by a rigging system.

97. The method of claim 95, further comprising the step of varying the buoyancy of the turbine assembly to assist to move said turbine assembly towards the raised position.

98. A water flow actuated turbine system comprising:
a support adapted to be at least partially submerged within a body of flowing water;
an elongate member supporting a turbine assembly at one end and being pivotally coupled at an opposite end to the support, the elongate member being pivotable to move the turbine assembly between raised and lowered positions; and
a float arrangement comprising a float member coupled to at least one of the elongate member and turbine assembly via a rigging system, wherein the buoyancy of the float member is variable to raise and lower the float member relative to the support to cause the elongate member to pivot to move the turbine assembly between raised and lowered positions.

99. The system of claim 98, wherein the float member is located within the support.

100. The system of claim 98, wherein the float member is adapted to be submerged within a volume of water within said support to varying degrees by varying the buoyancy of said float member.

101. The system of claim 98, wherein the buoyancy of the float member is variable by varying the proportions of water and air contained therein.

102. The system of claim 98, wherein the float arrangement further comprises a pumping system adapted to pump water into and from the float member.

103. The system of claim 102, wherein the pumping system is adapted to displace water from within the support and into the float member, and vice versa.

104. A lifting arrangement for use in a water flow actuated turbine system comprising an elongate member carrying a turbine assembly, said elongate member being pivotally mounted on a support adapted to be at least partially submerged in a body of water, wherein the elongate member is pivotable to move the turbine assembly between raised and lowered positions, said lifting arrangement comprising:
a float member coupled to at least one of the elongate member and turbine assembly via a rigging system, wherein the buoyancy of the float member is variable to raise and lower the float member relative to the support to cause the elongate member to pivot to move the turbine assembly between raised and lowered positions.

105. A water flow actuated turbine system comprising;
a support adapted to be at least partially submerged within a body of flowing water;
a turbine assembly mounted on the support and adapted to be moved between a raised position in which the turbine assembly is at least partially removed from the body of water, and a lowered position in which the turbine assembly is at least partially submerged within the body of water; and
a float arrangement comprising a float member coupled to the turbine assembly via a rigging system, wherein the buoyancy of the float member is variable to raise and lower the float member relative to the support to move the turbine assembly between said raised and lowered positions.

106. The system of claim 105, wherein the float member is directly coupled to the turbine assembly via the rigging system.

107. The system of claim 105, wherein the float member is indirectly coupled to the turbine assembly by the rigging system.
